(19) United States
(12) Patent Application Publication
(10) Pub. No.: US 2026/0268907 A1
(43) Pub. Date: Sep. 10, 2026

(54) VOICE-BASED CONVERSATION ARTIFICIAL INTELLIGENCE FOR POINT-OF-SALE SYSTEMS

(71) Applicant: Salesforce, Inc., San Francisco, CA (US)

(72) Inventors: Nitin MANGTANI, Los Altos, CA (US); Sandilya GARIMELLA, Mountain View, CA (US); Viswanth CHADALAWADA, Mountain View, CA (US); Madhav SAHU, Mountain View, CA (US)

(73) Assignee: Salesforce, Inc., San Francisco, CA (US)

(21) Appl. No.: 19/549,498

(22) Filed: Feb. 25, 2026

Related U.S. Application Data
(63) Continuation of application No. PCT/US2024/043437, filed on Aug. 22, 2024.
(60) Provisional application No. 63/535,901, filed on Aug. 31, 2023.

(51) Int. Cl. G10L 15/22; G06F 3/041; G06F 3/16; G06Q 20/20; G10L 15/16; G10L 15/26

(52) U.S. Cl. CPC G10L 15/22; G06F 3/0412; G06F 3/167; G06Q 20/20; G10L 15/16; G10L 15/26; G10L 2015/223

(57) ABSTRACT

A conversational artificial intelligence (AI) point-of-sale (POS) system uses generative AI to help a store associate complete tasks in a retail environment. This POS system combines four technologies: (1) speech recognition; (2) natural language processing; (3) acting in response to verbal command in the context of a retail store and a POS device; and (4) providing bi-directional and fully conversational responses. The AI, which runs in an app on a smartphone, tablet, or other mobile device, uses a machine learning (ML) model, such as a small language model (SLM) or large language model (LLM), that is trained against support tickets and other product documentation. The AI understands dependencies (e.g., the tills should be reconciled before closing the store) and predict appropriate responses to conversational inputs.

### CROSS-REFERENCE TO RELATED APPLICATIONS

This application is a continuation of international patent application number PCT/US2024/043437, having an international filing date of Aug. 22, 2024, which claims the priority benefit, under 35 U.S.C. 119 (e), of U.S. Application No. 63/535,901, filed on Aug. 31, 2023, which is incorporated herein by reference in its entirety for all purposes.

### BACKGROUND

A point-of-sale (POS) system is a device or set of devices that a merchant can use to sell something to a customer. The POS system calculates the cost of the goods and applicable taxes, logs the date and time of the transaction, and generates receipts for the merchant and the customer. A modern POS system can process credit or debit card transactions and update the merchant's inventory to reflect the sale. A modern POS system also supports omnichannel retail (integration of online and offline retail presence, such as fulfilling online orders in retail stores), clienteling (techniques for establishing long-term relationships with customers based on their preferences, behaviors, and purchases), store operations, and inventory management.

### SUMMARY

An inventive point-of-sale (POS) system marries four technologies: (1) speech recognition; (2) natural language processing; (3) acting in response to verbal command in the context of a retail store and a POS device; and (4) providing bi-directional and fully conversational responses. The marriage of these technologies provides a voice-based natural language processing (NLP) interface that enables more sophisticated interactions for omnichannel retail, clienteling, store operations, and inventory management.

An inventive POS system includes a microphone, a processor operably coupled to the microphone, and a memory operably coupled to the processor. In operation, the microphone to receive a spoken input from a sales associate, store manager, customer, or another person. The memory stores a small language model (SLM) which, when executed by the processor, causes the processor to convert the spoken input to text, classify the text with the SLM, and identify and perform an action in response to classification of the text. The SLM, which may be a bidirectional long short-term memory neural network, can be trained on training data generated from previous rules-based responses to previous spoken inputs, support tickets for the POS system, and/or documentation for the POS system. The POS system can also include a touchscreen operably coupled to the processor, in which case the action can comprise navigating to a page specified by a deep link and displaying the page on the touchscreen. The POS system may also include a speaker operably coupled to the processor, in which case the action may include generating a response to the spoken input and playing the response over the speaker.

An inventive POS system can operate by receiving, with the microphone, a spoken conversational input from a user; converting the spoken conversational input into text; classifying the text with the SLM; generating, by the SLM, a deep link action string based on the text; and performing an action specified by the deep link action string, such as navigating to a page specified by the deep link action string and displaying the page on a screen of the mobile device. The mobile device can also fetch the SLM from a server based on the text.

An SLM for a conversational POS system can be trained as follows. Text is extracted from support tickets for the POS system and/or documentation for the POS system, then annotated with labels to form a corpus of annotated data. The corpus of annotated data is split into a set of training data and a set of validation data. The SLM is trained on the set of training data, then validated or tested on the set of validation data. The SLM is integrated with an app, which is then installed on a mobile device of the POS system. The SLM can be converted to a format compatible with the mobile device (e.g., the Core ML format for iOS device) before being integrated with the app. If desired, the set of training data (and the set of validation data) can be tokenized into token sequences, which are then padded to uniform lengths, with the labels (annotations) encoded into vectors.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1A illustrates a voice-based, conversational artificial intelligence (AI) point-of-sale (POS) system.

FIG. 1B is a block diagram of a mobile device suitable for use in the voice-based, conversational AI POS system of FIG. 1A.

FIG. 2 illustrates a process for building and deploying a machine-learning (ML) model for a voice-based, conversational AI POS system.

FIG. 3 illustrates a process for using a voice-based, conversational AI POS system.

### DETAILED DESCRIPTION

A traditional POS system, such as a cash register, relies on manual input-fingers pushing buttons. Since the buttons' functions are fixed, a traditional POS system can perform only a limited number of operations, and those operations can only be performed by hand. Even a modern POS system that uses an app running on a mobile device such as a smartphone or tablet is limited to input via buttons appearing on a touchscreen. Although touchscreen buttons may be more easily reconfigured than buttons or keys on a cash register, they can still only accept a limited range of input and must be actuated manually.

An inventive POS system, on the other hand, includes a microphone to receive spoken or voice-based inputs. These spoken inputs can be in the form of simple commands (e.g., “Print receipt”), pre-programmed catch phrases (e.g., “Show me . . . ”), or more complicated free-form questions or instructions (e.g., “How many sleeveless red dresses in size 4 are in stock right now?”) that are interpreted using a properly trained machine-learning model executed on the POS system. The microphone converts the words spoken by a sales manager or sales associate into electronic signals.

A processor coupled the microphone converts the electronic signals to text using natural language processing (NLP), which combines computational linguistics-rule-based modeling of human language—with statistical, machine learning (ML), and/or deep learning models. In other words, the processor performs speech recognition or speech-to-text conversion. The processor can also use NLP to perform other functions, including speech tagging, word sense disambiguation, named entity recognition, and/or co-reference resolution. For instance, the processor can distinguish the noun in a spoken command (e.g., “dress” in “How many sleeveless red dresses in size 4 are in stock right now?”) using speech tagging. Similarly, the processor can identify a person (e.g., “the manager” or “Mary”) or an item (e.g., “the Emery Cashmere Sweater”) using named entity recognition. And the processor can determine whether two different words refer to the same thing (e.g., “it=the shirt” or “she=Nisha”) using co-reference resolution.

The POS system can also use a rules engine and/or a trained ML model, such as a trained small language model (SLM) based on hundreds to thousands of documents or a trained large language model (LLM) based on hundreds of millions of documents, to identify and carry out one or more suitable actions in response to the spoken inputs. A rules engine can identify actions to carry out in response to simple commands, catch phrases, and inputs via the POS system's touchscreen or other manual interfaces. For instance, the POS system can follow rules maintained by a rules engine to open a cash drawer in response to the spoken commands “Open cash drawer” or “Open till” or an appropriate touch on a touchscreen. These rules can be customized and/or updated to match the retail environment, suggested procedures for sales associates, and/or the items being sold in the retail environment.

The POS system can use a trained ML model to identify and carry out more sophisticated actions in response to freeform commands and queries. If the POS system detects a sales manager or sales associate saying, “Let's get ready for closing” or “It's time to close the store,” for example, the ML model can determine a series of steps or actions to carry out in order to prepare for closing, including playing announcements to customers indicating that the store is going to close, locking doors, and/or preparing cash drawers for reconciliation. The ML model can perform unstructured actions in response to natural-language commands and queries, such as generating natural-language responses to the commands or queries (e.g., responding to a query about sleeveless red dresses by saying, “There are two sleeveless red dresses in stock right now” or “There aren't any sleeveless red dresses in stock right now, but there are sleeveless blue dresses in stock”) using NLP. A speaker operably coupled to the processor can play these responses back to the user.

The ML model can be trained to provide more sophisticated responses to freeform spoken input using input generated through a user's rules-based interactions with the POS system. For instance, suppose that whenever a sales associate queries a POS system about the inventory status of a given item and receives a null result (e.g., “the item is not in stock”) using a manual interface (e.g., a touchscreen) or catch phrase, the sales associate searches for similar items (e.g., items of the same type and size but of different colors). Or suppose that whenever a sales associate queries a POS system about the inventory status of a given item and receives a positive result (e.g., “the item is in stock”) using a manual interface or catch phrase, the sales associate searches for matching accessories (e.g., if the item is a shirt, the sales associate searches for matching pants or a tie). Similarly, suppose the sales associate usually performs a given series of actions in sequence (e.g., open the cash drawer, print receipt, and update inventory). The POS system can record these cascaded inputs and associated actions as training data for the machine-learning model. When trained on this training data, the ML model enables the POS to provide more sophisticated responses to freeform instructions and queries, including autonomously suggesting alternative or additional items in response to a query for a specific item or initiating a cascade of actions in response to a spoken command to close the store for the day.

### Voice-Based Conversational AI POS System Architecture

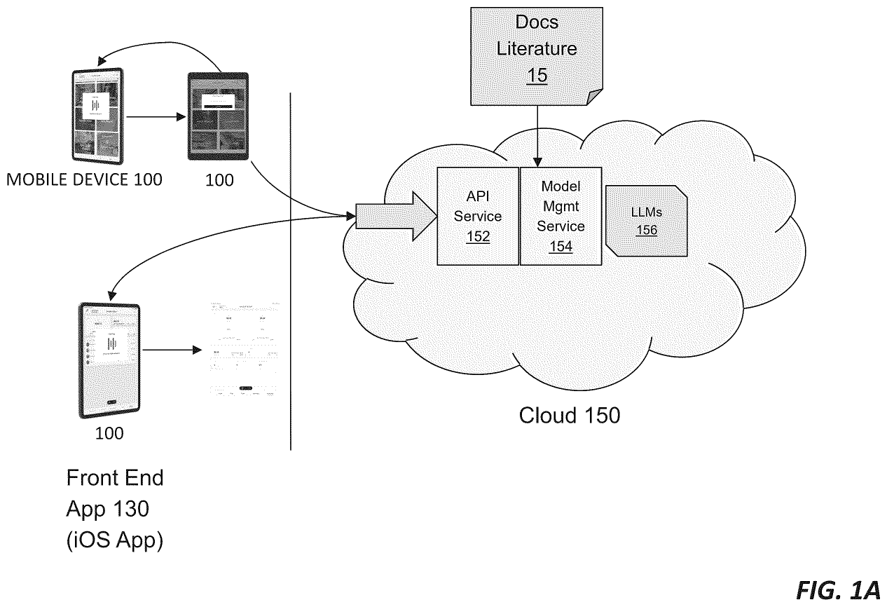

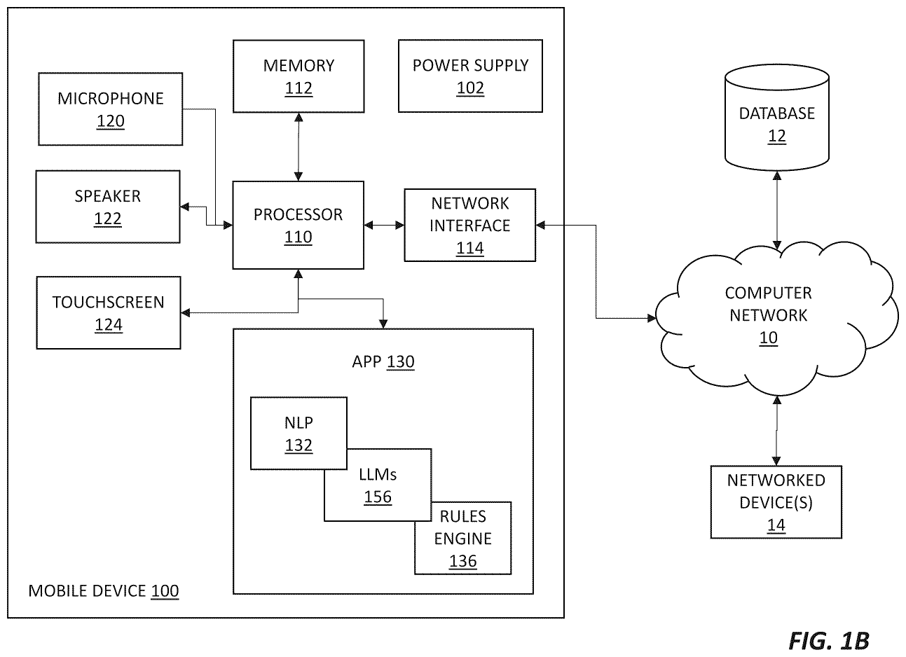

FIG. 1A illustrates the architecture of a voice-based conversational AI POS system. This system includes a mobile device 100, such as a tablet or smart phone, that runs a front end app 130 (e.g., an iOS or Android app) for processing and responding to voice commands via the mobile device's microphone and speaker (shown in FIG. 1B, described below). The app 130 provides both a voice assistant interface and voice recognition. The user interacts with the voice assistant interface: The user interacts with the app 130 via the voice assistant interface, which can be built using Swift and can leverage speech and NLP frameworks native to the mobile device's operating system. The app 130 uses the voice recognition to capture voice input from the user and transcribe the voice input to text through the speech framework.

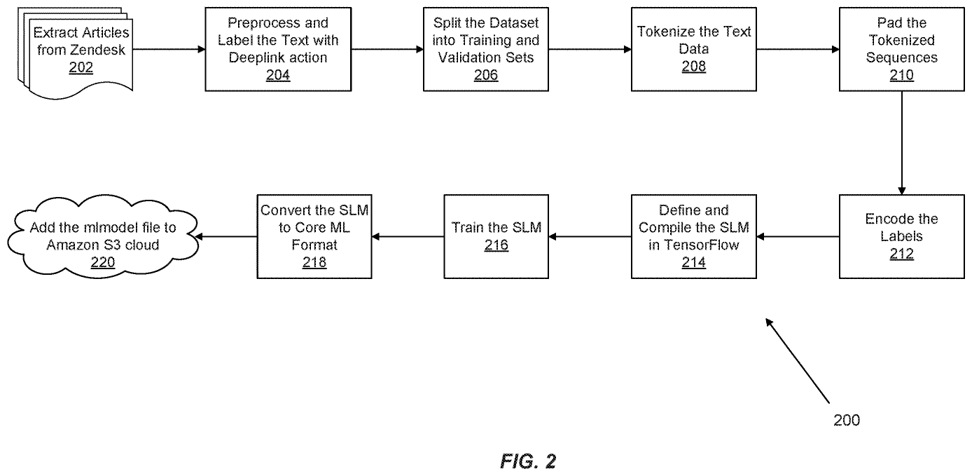

The voice-based conversational AI POS system also includes an application programming interface (API) server 152 and a ML model management service 154 deployed on a cloud 150. The API server 152 communicates with the app 130 via a (wireless) network interface in the mobile device 100. In operation, the API server 152 handles requests from the app 130, including requests for small language models (SLMs) 156. As described below with respect to FIG. 2, the SLMs 156 are trained via product documentation, store training material, and other literature with retail language 15. The ML model management service 154 manages and stores SLMs, LLMs, and other ML models in a backend database or file storage system. The API server 152 fetches the SLMs in response to requests from the app 130, which uses the SLMs to predict deep link actions based on the transcribed user speech. Each deep link action launches a specific view or screen inside the app for the user, for example, a view of a page for transacting a product purchase, exchange, or return; a page showing information about product inventory or other store-level sales information; or a page allowing the user to manage a customer's account or the store's IT infrastructure. TABLE 1 (below) lists several example deep link strings and the actions that cause the app to perform:

TABLE 1
Example Deep Link Strings and Actions

| Deep Link Strings | Action by App |
|---|---|
| devicemanager | Opens Device manager screen to manage printers, |
| | scanners and card readers |
| createPurchaseOrder | Opens new purchase order screen |
| purchaseOrderHistory | Navigates to all purchase order history screen |
| gmvReport | Navigates to GMV report screen |
| transfershistory | Navigates to inventory transfer history screen |

This architecture can employ several security features, including secure authentication for interactions between the app 130 and the backend (API server 152). For instance, the app 130 and API server 152 can encrypt data in transit (e.g., using the hypertext transfer protocol secure (HTTPS)) and at rest to protect user information and ML model data. The app 130 and API server 152 may also transfer trained ML models securely to prevent tampering or unauthorized access.

FIG. 1B illustrates aspects of the inventive voice-based conversational AI POS system of FIG. 1A in greater detail, particularly the mobile device 100. The mobile device 100 includes a microphone 120, speaker 122, touchscreen 124 (or display and keyboard or other manual user interface), processor 110, memory 112, (wireless) network interface 114, and power supply 102 (e.g., a rechargeable battery) that provides electrical power to the other electrical components. The microphone 120 receives and transduces voices commands from a sales associate, store manager, or other user into electronic signals for processing with an app 130 that is executed by the processor 110 and optionally uses an NLP framework 132 to interpret and respond to spoken commands and queries detected by the microphone 120. The speaker 122 plays responses generated by the app 130 back to the sales associate. And the touchscreen 124 can be used to accept or solicit additional user input and/or to provide additional output to the user. For instance, the touchscreen 124 can show receipts, product information, or even a map illustrating the location of products, dressing rooms, or other points of interest.

Depending on the command or query, the app 130 may interact with a remote database 12 or other networked device 14 via the network interface 114. For instance, to answer a sales associate's question about whether a particular product is in stock, the app 130 may query the remote database 12. Similarly, the app 130 may update the remote database 12 after transacting a sale or return to reflect the change in inventory. The app 130 may also interact with other networked devices 14, such as networked cash registers, alarms, lights, or doors, when executing commands involving sales or other store operations. If a sales associate asks whether a particular item is in stock, for example, the app 130 may cause a networked light near the item's location to flash, dim, or blink.

The app's optional NLP framework 132 can parse the sales associate's instructions grammatically, e.g., into verbs, adjectives, and nouns, and use the parsed components to determine which actions to take. The NLP framework 132 can be trained on verbs, adjectives, nouns, and other (types of) words specific to the environment in which the POS system will be used. If that environment is a particular retail store, for example, then the NLP framework 132 may be trained to recognize words relating to items sold in that retail store or the jargon used by sales associates in that retail store.

The app 130 uses a trained SLM 156 or other ML model and optional rules engine 136 to identify and carry out one or more suitable actions in response to the output of the NLP framework 132. The app 130 uses the rules engine to identify and carry out actions in response to spoken commands or catch phrases, which can be processed directly by the SLM 156 or with the NLP framework 132, and to inputs via the touchscreen 124. The app 130 uses the SLM 156 to process conversational phrases, queries, implicit commands, and explicit commands that are more complex than predetermined catch phrases or imperatives. (The app 130 can also use the NLP 132 to process these more complicated phrases and an ML model to respond to the corresponding NLP outputs.) The app 130 also uses the trained SLM 156 to identify and carry out more sophisticated actions in response to these conversational inputs, including unstructured actions, including generating natural-language responses that are played to the user over the speaker 122.

### Building and Deploying an ML Model for Voice-Based Conversation AI POS System

FIG. 2 illustrates a process 200 for training an SLM (e.g., SLM 156 in FIGS. 1A and 1B) on an appropriate processor and integrating it with a voice-based conversational AI POS system like those shown in FIGS. 1A and 1B. The process 200 starts with generating training data by extracting raw data (202), such as articles, training data generated from previous rules-based responses to previous spoken inputs, support tickets for the POS system, and/or documentation for the POS system, including user manuals or Wiki pages. For instance, the raw data may include articles extracted from Zendesk or another suitable platform using an appropriate Applicant Programming Interface (API) and saving the fetched articles. The following pseudocode fetches articles from Zendesk using the Zendesk API and saves them to a JavaScript Object Notation (JSON) file:

```
import requests
import json
# Your Zendesk credentials
subdomain = ‘your_subdomain’
email = ‘your_email’
password = ‘your_password’
# API endpoint for articles
url= f‘https://{subdomain}.zendesk.com/api/v2/help_center/articles.json’
# Request headers
headers = {
  ‘Content-Type’: ‘application/json’
}
# Make the request
response = requests.get(url, auth=(email, password), headers=headers)
if response.status_code == 200:
  articles = response.json( )
  with open(‘zendesk_articles.json’, ‘w’) as f:
    json.dump(articles, f, indent=4)
else:
  print(‘Failed to retrieve articles:’, response.status_code)
```

Next, the raw text data is preprocessed and labeled with an appropriate deep link action (e.g., a deep link string like those shown in TABLE 1) for the POS system to take in response to the text (204). The processor training the SLM loads the JSON file containing the articles and/or other documentation, then extracts relevant text from the articles and/or other documentation. Each text excerpt is manually annotated with a corresponding deep link action, and the annotated text data is saved, e.g., as a comma-separated value (CSV) file.

The following pseudocode imports a JSON file, extracts and annotates articles in the JSON file, and saves the annotated data as a CSV file:

```
import json
import pandas as pd
# Load articles
with open(‘zendesk_articles.json’, ‘r’) as f:
  articles = json.load(f)
# Extract relevant information and annotate
data = [ ]
for article in articles[‘articles']:
  text = article[‘body’]
  # Manually annotate the text here with actions
  action = input(f“Enter action for the following text:\n{text}\nAction: ”)
  data.append({“Text”: text, “Action”: action})
# Save the annotated data to CSV
df = pd.DataFrame(data)
df.to_csv(“actions_dataset.csv”, index=False)
```

The processor then splits the annotated data into a set of training data and a set of validation data (206) and prepares the training data for training the SLM. For instance, the processor may use 80% of the annotated data for training the ML model and 20% of the annotated data for validating the trained SLM (other split percentages are also possible). Next, the processor tokenizes the training and validation data (208)—that is, the processor substitutes a randomly generated identifier for each annotated text excerpt. It does this by initializing a tokenizer, fitting the tokenizer on the training data, and converting the training data into token sequences using the tokenizer. Tokenization is a step in the process of transforming raw text into a format suitable for SLMs and other ML models. Tokenization standardizes text, reduces complexity, and enables the SLMs and/or other ML models to learn patterns and relationships in the data, ultimately making accurate classifications. The processor pads the resulting token sequences to ensure that they are all the same (uniform) length instead of different lengths (210). The processor also encodes the labels (212) by converting the labels, which are entered as text (e.g., deep link strings), into numerical format, then encoding the numerical labels into one-hot vectors.

Once the training data has been tokenized and the labels have been encoded, the processor defines and compiles the SLM (214), e.g., in TensorFlow or another suitable ML platform. For example, the processor may define the SLM as a bidirectional long short-term memory (BiLSTM) neural network for text classification and compile the BiLSTM neural network with an appropriate loss function and optimizer. Other suitable types of SLMs and LLMs include but are not limited to recurrent neural networks, gated recurrent units, convolutional neural networks, capsule networks, and sequence-to-sequence models. A BiLSTM neural network is particularly well suited for use in a trained SLM because it captures past and future context simultaneously, enhancing its ability to understand the meaning of a word based on surrounding words in both directions. This bidirectional processing provides a more comprehensive understanding of the text than models that consider context in only one direction or models that do not explicitly model sequential dependencies. The processor trains the compiled SLM on the tokenized training data (216), validates the trained ML model on the validation data, and saves the trained SLM to a file.

The following pseudocode prepares the training and validation data, then defines, compiles, trains, and saves the SLM according to the steps described immediately above:

```
pip install tensorflow
import pandas as pd
import tensorflow as tf
from tensorflow.keras.preprocessing.text import Tokenizer
from tensorflow.keras.preprocessing.sequence import pad_sequences
from sklearn.model_selection import train_test_split
# Load the dataset
df = pd.read_csv(‘actions_dataset.csv’)
# Split the dataset into training and validation sets
train_texts, val_texts, train_labels, val_labels = train_test_split(
  df[‘Text’].tolist( ), df[‘Action’].tolist( ), test_size=0.2
)
# Tokenize the text
tokenizer = Tokenizer(num_words=5000, oov_token=‘<OOV>’)
tokenizer.fit_on_texts(train_texts)
train_sequences = tokenizer.texts_to_sequences(train_texts)
val_sequences = tokenizer.texts_to_sequences(val_texts)
# Pad the sequences
max_length = 100
train_padded = pad_sequences(train_sequences, maxlen=max_length, padding=‘post’,
truncating=‘post’)
val_padded = pad_sequences(val_sequences, maxlen=max_length, padding=‘post’,
truncating=‘post’)
# Encode the labels
label_tokenizer = Tokenizer( )
label_tokenizer.fit_on_texts(train_labels)
train_label_seq = label_tokenizer.texts_to_sequences(train_labels)
val_label_seq = label_tokenizer.texts_to_sequences(val_labels)
# Convert labels to one-hot encoding
train_labels_one_hot = tf.keras.utils.to_categorical(train_label_seq)
val_labels_one_hot = tf.keras.utils.to_categorical(val_label_seq)
# Define the model
model = tf.keras.Sequential([
  tf.keras.layers.Embedding(5000, 64, input_length=max_length),
  tf.keras.layers.Bidirectional(tf.keras.layers.LSTM(64)),
  tf.keras.layers.Dense(64, activation=‘relu’),
  tf.keras.layers.Dense(len(label_tokenizer.word_index) + 1, activation=‘softmax’)
])
model.compile(loss=‘categorical_crossentropy’, optimizer=‘adam’, metrics=[‘accuracy’])
# Train the model
history = model.fit(
  train_padded, train_labels_one_hot,
  epochs=10,
  validation_data=(val_padded, val_labels_one_hot),
  verbose=2
)
# Save the model
model.save(‘text_classification_model.h5’)
```

If desired, the processor can convert the trained SLM to a different format that is suitable for execution on the mobile device (218), such as the Core ML format for execution on an iOS device, such as an iPad or iPhone. To do this, the processor loads the trained SLM, converts the trained SLM to the desired format (e.g., Core ML format) using the appropriate tools (e.g., Core ML tools), and saves the converted, trained SLM to a file. The following pseudocode converts a trained ML model to Core ML format:

pip install coremltools
import coremltools as ct
import tensorflow as tf
# Load the trained model
model = tf.keras.models.load_model(‘text_classification_model.h5’)
# Convert to Core ML
mlmodel = ct.convert(model, inputs=[ct.TensorType(shape=(None, max_length))])
# Save the Core ML model
mlmodel.save(‘TextClassificationModel.mlmodel’)

### Using a Voice-Based Conversational AI POS System

Once the trained ML model has been converted into a format that can be executed by the mobile device, the trained ML model is integrated into the app that runs on the mobile device (220) and deployed. For a mobile device that runs on an iOS operating system (e.g., an iPhone or iPad), the processor adds the trained ML model in Core ML format to the cloud (e.g., an Amazon S3 cloud storage object). When the user launches the app on the mobile device, the app makes an API call to the API server for the trained ML model. The API server returns the trained ML model from the cloud to the app, which stores the trained ML model in the app's local document directory in the mobile device's local memory.

In operation, the user speaks to the voice assistant, which captures and optionally transcribes the voice input. The app requests the relevant ML model (e.g., a trained SLM) from the backend if it is not already available on the mobile device's local memory. The ML model uses the transcribed text to predict one or more deep link actions. Based on the selected deep link action, the app navigates to and displays the appropriate page(s) to the user via the mobile device's touchscreen 124. For example, if the user says, “Let's create a new cycle count,” the ML model may determine that the user wants to create a type of “CreateCycleCount,” navigate to a page where a new cycle count can be initiated, and display the page on the touchscreen 124. Similarly, if the user says, “Show me store analytics dashboard,” the ML model may determine that the user wants to view the “StoreAnalyticsDashboard,” navigate to the store analytics dashboard screen, and display the page on the touchscreen 124.

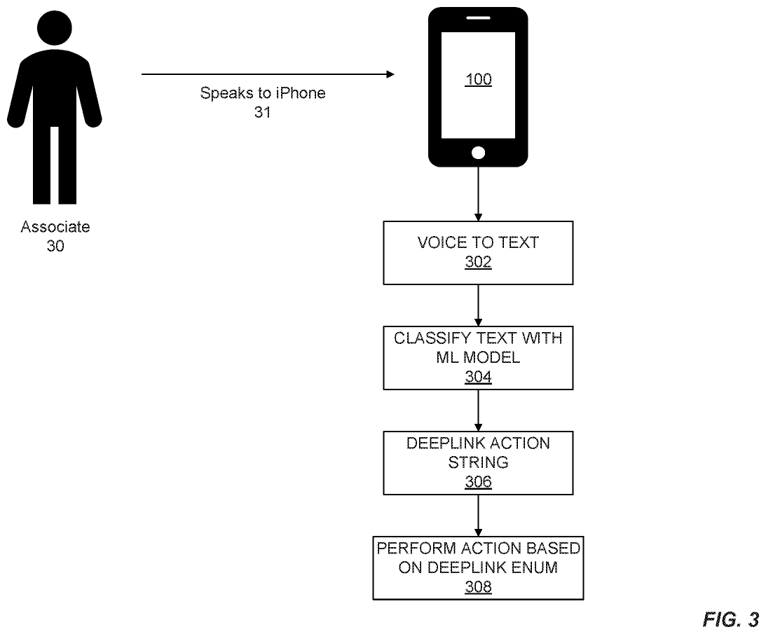

FIG. 3 illustrates how the app 130 operates. Using the mobile device's microphone 120 (FIG. 1B), the app 130 captures speech 31 uttered by a sales associate 30 or other user. The app transcribes the user's speech (302) to text and uses the locally saved trained ML model to classify the text 303 (304). If desired, the app 130 can uses the NLP framework 132 to identify verbs and nouns in the text, then parses the result. The app gets a deep link action in string format (306) and performs an action based on the deep link enum (308). Suitable actions include, but are not limited to:
createCycleCount—navigates to a screen where the cycle count process can be initiated;
storeAnalyticsDashboard—navigates to store analytics dashboard screen;
associateLoginReport—Navigates to associate login report screen;
switchPrinter—shows an option to choose printer type;
cashPayment—initiates cash payment for a cart items; and
transactionDiscount—shows option to apply or remove discount on order,
   where deep link enums are static values like createCycleCount, storeAnalyticsDashboard, associateLoginReport, switchPrinter, cashPayment, transactionDiscount, etc. that correspond to the deep link action. More generally, each deep link action causes the app to display a particular page on the mobile device's touchscreen or display, enabling the user (e.g., a sales associate or store manager) to perform a customer transaction, track store inventory or performance, or manage the store's information technology (IT) infrastructure.

When executed by the mobile device, the following pseudocode loads and uses the trained ML model:

```
import CoreML
import NaturalLanguage
func loadModel(at url: URL) -> MLModel? {
  do {
    let compiledModelURL = try MLModel.compileModel(at: url)
    let model = try MLModel(contentsOf: compiledModelURL)
    return model
  } catch {
    print(“Error loading the model: \(error)”)
    return nil
  }
}
func classifyText(_text: String, with model: MLModel) -> String? {
  let textClassifier = try? NLModel(mlModel: model)
  return textClassifier?.predictedLabel(for: text)
}
// Example usage
downloadModel { modelURL in
  guard let modelURL = modelURL, let model = loadModel(at: modelURL) else {
    print(“Failed to load the model”)
    return
  }
  let classification = classifyText(“Sample text to classify”, with: model)
  print(“Classification: \(classification ?? “Unknown”)”)
}
```

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/or” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A point-of-sale (POS) system comprising:
a microphone to receive a spoken input;
a processor operably coupled to the microphone; and
a memory operably coupled to the processor and storing a small language model (SLM) which, when executed by the processor, causes the processor to convert the spoken input to text, classify the text with the SLM, and identify and perform an action in response to classification of the text.

2. The POS system of claim 1, wherein the SLM is trained on training data generated from previous rules-based responses to previous spoken inputs, support tickets for the POS system, and/or documentation for the POS system.

3. The POS system of claim 1, wherein the SLM is a bidirectional long short-term memory neural network.

4. The POS system of claim 1, further comprising:
a touchscreen operably coupled to the processor,
wherein the action comprises navigating to a page specified by a deep link and displaying the page on the touchscreen.

5. The POS system of claim 1, further comprising:
a speaker operably coupled to the processor,
wherein the action comprises generating a response to the spoken input and playing the response over the speaker.

6. A method of operating a conversational point-of-sale (POS) system, the method comprising:
receiving, with a microphone on a mobile device, a spoken conversational input from a user;
converting, by the mobile device, the spoken conversational input into text;
classifying, by a small language model (SLM) executing on the mobile device, the text;
generating, by the SLM, a deep link action string based on the text; and
performing, by the mobile device, an action specified by the deep link action string.

7. The method of claim 6, wherein the SLM is a bidirectional long short-term memory neural network.

8. The method of claim 6, wherein performing the action specified by the deep link action string comprises:
navigating to a page specified by the deep link action string; and
displaying the page on a screen of the mobile device.

9. The method of claim 6, further comprising:
fetching, by the mobile device, the SLM from a server based on the text.

10. A method of training a small language model (SLM) for a conversational point-of-sale (POS) system, the method comprising:
extracting text from support tickets for the POS system and/or documentation for the POS system;
annotating the text with labels to form a corpus of annotated data;
splitting the corpus of annotated data into a set of training data and a set of validation data;
training the SLM on the set of training data;
validating the SLM on the set of validation data;
integrating the SLM with an app; and
installing the app on a mobile device of the POS system.

11. The method of claim 10, wherein the SLM is a bidirectional long short-term memory neural network.

12. The method of claim 10, wherein integrating the SLM with the app comprises converting the SLM to a format compatible with the mobile device.

13. The method of claim 12, wherein the format is the Core ML format.

14. The method of claim 10, further comprising:
tokenizing the set of training data into token sequences; and
encoding the labels in the set of training data.

15. The method of claim 14, further comprising:
padding the token sequences to uniform lengths.

16. The method of claim 14, further comprising:
tokenizing the set of validation data.
